(19) United States
(12) Patent Application Publication
(10) Pub. No.: US 2001/0036983 A1
(43) Pub. Date: Nov. 1, 2001

(54) Inhibiting discoloration of halogen-containing polymers after radiation

(75) Inventors: Qi Wang, Grand Island, NY (US); Sandor Nagy, Grand Island, NY (US); Mary K. Cocoman, Grand Island, NY (US); Thomas F. Smolka, Amherst, NY (US); Mingzhu Xu, Amherst, NY (US)

Correspondence Address: OCCIDENTAL CHEMICAL CORPORATION, 5005 LBJ Freeway, Dallas, TX, 75244, US

(73) Assignee: Occidental Chemical Corporation.

(21) Appl. No.: 09/877,450

(22) Filed: Jun. 11, 2001

Related U.S. Application Data
(62) Division of application No. 09/213,779, filed on Dec. 17, 1998.

(51) Int. Cl. C08K 5/51

(52) U.S. Cl. 524/137; 524/241

(57) ABSTRACT

Disclosed is a method of inhibiting the discoloration of a halogen-containing polymer, particularly poly(vinyl chloride), after exposure to gamma radiation. About 0.0001 to about 5 wt % of a dithiocarbamate or a dithiophosphate stabilizer is added to the polymer. The stabilizer can be added during polymerization or during compounding. Also disclosed is a composition of a halogen-containing polymer and a dithiocarbamate or dithiophosphate stabilizer.

### BACKGROUND OF THE INVENTION

This invention relates to inhibiting the discoloration of a halogen-containing polymer after it has been exposed to gamma radiation. In particular, it relates to the addition of a dithiocarbamate, dithiophosphate, or a complex thereof to the polymer for that purpose.

Poly(vinyl chloride) (PVC), one of the most versatile thermoplastic polymers, is used for many medical applications. Consumption of this polymer in the medical field was estimated to be more than 800 million lbs (363 million kg) in 1997, making it the leading polymeric material used for medical devices and packaging applications in terms of volume. The popularity of PVC in the medical industry is due to its clarity, gloss, unique versatility, excellent functional performance, inertness to fluids, and relatively low cost.

Generally, medical devices and related items have to be sterilized before they are used. While ethylene oxide sterilization imposes virtually no or very little harmful effect on the physical properties of PVC, gamma radiation sterilization can severely diminish certain physical characteristics of PVC. In particular, it can change its color, usually by yellowing. Since the color change gives an impression of inferior quality, the color problem is probably the most important issue facing PVC manufacturers when marketing medical grade PVC.

### SUMMARY OF THE INVENTION

We have discovered that certain dithiocarbamates, dithiophosphates, and complexes thereof stabilize halogen-containing polymers, especially PVC, by inhibiting the yellowing of these polymers after they have been exposed to gamma radiation. These stabilizers can be added to halogen-containing polymers, during polymerization, drying, and compounding.

### DESCRIPTION OF THE PREFERRED EMBODIMENTS

The dithiocarbamates and dithiophosphates used in this invention are salts that have the general formula:

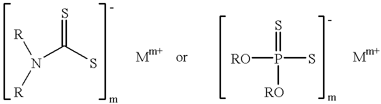

where

R is alkyl, aryl, (aryl)alkyl, (alkyl)aryl, (alkyoxyl)alkyl, (alkylthio)alkyl, alkylene, or phenylene from C₁ to C₁₂, preferably from C₂ to C₆, M is a divalent or multivalent metal ion, and m is the valence of M; m is preferably 2 and M is preferably zinc as those stabilizers work best. Other metals that can be used include calcium, magnesium, aluminum, cadmium, barium, tin, lead, nickel, thallium, and copper. Salts of monovalent ions, such as sodium and ammonium diethyldithiocarbamate, are not effective. When R is alkylene, coordination of the terminal sulfur with the metal atom can be either inter- or intramolecular. The R groups can also be a polymeric chain. These polymeric dithiocarbamates and dithiophosphates are expected to have less tendency to migrate out of the polymer:

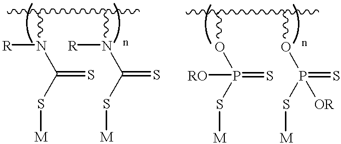

The polymeric backbone of these materials can have the structures of polyolefins, polystyrene, polyethers, polyesters, polysiloxanes, polyamines, polyamides, polyimides, polycarbonates, or another polymer.

Many of the zinc salt stabilizers used in this invention, such as zinc dimethyldithiocarbamate (ZDMDTG), zinc diethyldithiocarbamate (ZDEDTC), zinc dibutyldithiocarbamate (ZDBDTC), zinc dibenzyidithiocarbamate (ZDBenDTC), and zinc pentamethylene-dithiocarbamate (ZPMDTC) are commercially available. Those that are not available commercially can be prepared by reacting carbon disulfide with an appropriate amine follow by ion exchange with an appropriate metal salt. (Moore, A. J.; Bryce, M. R. Synthesis, 1997, 407.) The zinc salt of diethyidithiophosphate (ZDEDP) was prepared according to literature. (Drew, M. B.; Hasan, M.; Hobson, R. J.; Rice, D. A. JCS Dalton Trans., 1986, 1161.) The base complexes of these zinc salts were also prepared according published literature. (Higgins, G. M. C.; Savilie, B. JCS, 1963, 2812.)

A base can be added to the salt to form a simple complex having the general formula:

The base can also replace one of the dithio ligands to form a genuine salt containing both the dithio components and the base. These complexes and new

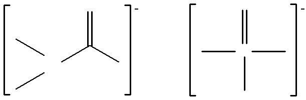

types of salts can be prepared separately in advance, or simply mixed in situ during compounding. Examples of suitable bases include nitrogen-based compounds such as amines (e.g., polycyclic 1,4-diazabicyclo[2,2,2]octane (DABCO)), imines, enamines, amides, nitrites, various heterocyclic nitrogen-containing compounds such as pyrroles, carbazoles, indoles, imidazoles, pyrazoles, triazoles, tetrazoles, pyridines, quinolines, pyrimidines, purines, diazines, triazines, and tetrazines, oxygen-based compounds, such as alcohols, phenols, ethers, epoxides, aldehydes, ketones, appropriate carboxylic acids and their esters, and oxygen-containing heterocyclic compounds, sulfur-containing compounds, such as thiols, thiophenols, thioethers, sulfoxides, sulfones, sulfates, sulfites, thiocarbonyl-containing compounds, sulfur-containing heterocyclic compounds, and phosphorus-containing compounds, including phosphines, phosphine oxides, and related molecules.

The stabilizer can be added to the polymer in several ways. For example, it can be mixed with the reaction components during the process of polymerization. It can also be charged into the reactor at the beginning of polymerization or added during various stages of the reaction. The addition of a stabilizer is preferably carried out after the monomer conversion has reached 70%. The stabilizer can also be added during the drying of the polymer or it can be compounded into a polymeric composition. Various methods can used for compounding, including milling, dry mixing, and extrusion. The amount of stabilizer should be about 0.0001 to about 5 wt %, based on the monomer weight, as less is ineffective and more is unnecessary; about 0.001 to about 0.4 wt % is preferred.

The composition generally comprises a mixture of the halogenated polymer, the anti-yellowing stabilizer, a plasticizer, a Ca/Zn heat stabilizer, epoxidized soybean oil, and other co-stabilizers as well as a lubricant. Other components that enable the polymeric composition to reach a specified performance can also be included. Examples of halogen-containing polymers that the stabilizers of this invention can be used with include PVC, polyvinylidene chloride, polyvinylidene fluoride, polyvinvyl fluoride, and their copolymers. The stabilizers are especially useful with PVC.

The following examples further illustrate this invention.

### EXAMPLES 1 TO 16

To a mixture of 150.00 g (100 phr) PVC (sold by Occidental Chemical Corp. as “Oxy 240”), 0.30 g (0.20 phr) stearic acid, 0.23 g (0.15 phr) of a salt of a long chain fatty acid (sold by Witco as “Mark 152 S”), 97.50 g (65.00 phr) dioctylphthalate (DOP), 15.00 g (10.00 phr) epoxidized soy bean oil (sold by Witco as “Drapex 6.8”), and other additives was added various amounts of a stabilizer. The mixture was thoroughly blended and hot milled at 300° F. (149° C.) for 5 minutes. The resulting PVC sheet was cut and pressed into a 4″×3″×1/4″ (10.2×7.6×0.6 cm) plaque at 330° F. (166° C.). The plaque was then divided into two smaller pieces, one for y radiation and the other for comparison. After being subjected to γ radiation at a dose of 50 kGy, the irradiated plaque was again divided into two pieces. One was oven aged at 50° C. for 48 hours. All of the samples were then measured for yellowness index (Y) as described by the Hunter equations (see “The Measurement of Appearance” by Richard S. Hunter, John Wiley & Sons, New York, 1975), using a Mascbeth 2020 Plus Color Eye Spectrometer. The following table gives the compositions tested and the results. Examples 14, 15, and 16 are comparative examples. In the table, DOA is dioctyl adipate, CPX is a comple of ZDEDC with 1,4-diazabicyclo[2,2,2]octane, ADEDTC is ammonium diethyidithiocarbamate, DEA-DEDTC is diethylammonium diethyldithiocarbamate, and SDEDTC is sodium diethyldithiocarbamate.

| | | | | | | Yellowness | | |
|---|---|---|---|---|---|---|---|---|
| | | | | blue M/B | | | After | After 48 |
| | | | DOA | dye | Na(BO₃)₄ | | 5.0 | hr at |
| Example | Stabilizer | (g) | (g) | (g) | (g) | Initial | Mrad | 50° C. |
| 1 | ZDEDTC | 0.31 | | | | 11.4 | 27.8 | 42.8 |
| | — | 0 | | | | 12.4 | 45.0 | 72.0 |
| 2 | ZDEDTC | 0.61 | | | | 14.5 | 26.1 | 393 |
| | — | 0 | | | | 12.4 | 45.0 | 72.0 |
| 3 | ZDEDTC | 0.92 | | | | 17.2 | 28.2 | 37.7 |
| | — | 0 | | | | 12.4 | 45.0 | 72.0 |
| 4 | ZDEDTC | 0.30 | 20.0 | | | 19.0 | 32.8 | 47.8 |
| | — | 0 | | | | 19.8 | 52.6 | 73.3 |
| 5 | ZDEDTC | 0.32 | | 1.65 | | 13.8 | 29.9 | 46.5 |
| | — | 0 | | 1.65 | | 13.9 | 48.6 | 70.5 |
| 6 | ZDEDTC | 0.62 | | 1.65 | | 15.0 | 27.6 | 39.0 |
| | — | 0 | | 1.65 | | 13.9 | 48.6 | 70.5 |
| 7 | ZDEDTC | 0.32 | | 1.65 | 0.35 | 12.4 | 28.6 | 44.4 |
| | — | 0 | | 1.65 | 0.35 | 13.9 | 48.6 | 70.5 |
| 8 | ZDEDTP | 0.35 | | | | 15.4 | 49.7 | 69.8 |
| | — | 0 | | | | 19.8 | 52.6 | 73.3 |
| 9 | ZDMDTC | 0.31 | | | | 24.2 | 37.1 | 50.8 |
| | — | 0 | | | | 17.0 | 54.4 | 76.6 |
| 10 | ZDBDTC | 0.47 | | | | 21.8 | 41.9 | 60.2 |
| | — | 0 | | | | 17.0 | 54.6 | 76.6 |
| 11 | ZPMDTC | 0.40 | | | | 23.5 | 38.7 | 55.6 |
| | — | 0 | | | | 17.0 | 54.6 | 76.6 |
| 12 | ZDBenDTC | 0.60 | | | | 20.9 | 45.7 | 63.0 |
| | — | 0 | | | | 17.0 | 54.6 | 76.6 |
| 13 | CPX | 0.47 | | | | 21.0 | 38.0 | 56.0 |
| | — | 0 | | | | 17.0 | 54.6 | 76.6 |
| 14 (C) | ADEDTC | 0.30 | | | | 23.1 | 54.9 | 89.4 |
| | 0 | | | | | 19.8 | 51.5 | 72.3 |
| 15 (C) | DEA-DEDTC | 0.30 | | | | 20.0 | 47.1 | 93.3 |
| | 0 | | | | | 12.4 | 45.0 | 72.0 |
| 16 (C) | SDEDTC | 0.31 | | | | 31.4 | 64.1 | 108.1 |
| | 0 | | | | | 12.4 | 45.0 | 72.0 |

(C) = Comparative example

The above experiments show that the compositions that contained a zinc salt of a dithiocarbamate or a dithiophosphate had significantly less discoloration after radiation sterilization than did control compositions that contained a dithiocarbamate salt of a monovalent cation, such as sodium or ammonium.

We claim:

1. A composition comprising a halogen-containing polymer and about 0.0001 to about 5 wt % of a dithiocarbamate or dithiophosphate stabilizer.

2. A method of inhibiting the discoloration of a halogen-containing polymer after exposure to gamma radiation comprising adding a composition according to claim 1 to said polymer.

3. A method according to claim 2 wherein said stabilizer has the general formula 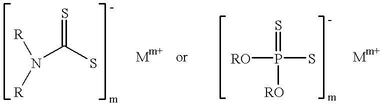
where each R is independently selected from alkyl, aryl, (aryl)alkyl, (alkyl)aryl, (alkyoxyl)alkyl, (alkylthio)alkyl, alkylene, and phenylene from C₁ to C₁₂, M is a di or multivalent metal, and m is the valence of M.

4. A method according to claim 3 wherein M is zinc.

5. A method according to claim 3 wherein each R is alkyl from C₂ to C₆.

6. A method according to claim 2 wherein said stabilizer is a polymer.

7. A method according to claim 2 wherein said stabilizer is a complex with an organic base.

8. A method according to claim 2 wherein said halogen-containing polymer is poly(vinyl chloride).

9. A method according to claim 2 wherein said stabilizer is a dithiocarbamate.

10. A method according to claim 2 wherein said stabilizer is a dithiophosphate.

11. A method according to claim 2 wherein said stabilizer is compounded with said polymer.

12. A method according to claim 2 wherein said stabilizer is added to said polymer during polymerization.

13. A method of inhibiting the discoloration of a halogen-containing polymer after exposure to gamma radiation comprising adding to said polymer about 0.001 to about 0.3 wt % of a dithiocarbamate stabilizer.

14. A method according to claim 13 wherein said stabilizer has the general formula
where 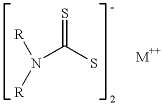
each R is independently selected from alkyl from C₂ to C₆ and M is a divalent metal.

15. A method according to claim 14 wherein M is zinc.

16. A method according to claim 14 wherein said halogen-containing polymer is poly(vinyl chloride).

17. A method of inhibiting the discoloration of a halogen-containing polymer after exposure to gamma radiation comprising adding to said polymer 0.001 to about 0.4 wt % of a zinc dithiocarbamate stabilizer.

18. A method according to claim 17 wherein said halogen-containing polymer is poly(vinyl chloride).

19. A method according to claim 17 wherein said stabilizer has the general formula
where each R 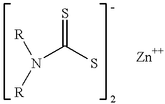
is independently selected from alkyl from C₂ to C₆.

20. A method according to claim 14 wherein R is ethyl.
